(19) United States
(12) Patent Application Publication
(10) Pub. No.: US 2009/0156196 A1
(43) Pub. Date: Jun. 18, 2009

(54) SYSTEM LEVEL INFORMATION FOR SYSTEM INFORMATION, PAGING AND MEASUREMENTS

(75) Inventors: Shankar Somasundaram, Deer Park, NY (US); Rajat P. Mukherjee, Stanford, CA (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/333,416

(22) Filed: Dec. 12, 2008

Related U.S. Application Data
(60) Provisional application No. 61/013,800, filed on Dec. 14, 2007.

(51) Int. Cl. H04W 24/00; H04B 17/00

(52) U.S. Cl. 455/423; 455/67.11

(57) ABSTRACT

A method and apparatus for performing non-serving cell measurements and determining cycles for monitoring system information updates. A wireless transmit receive unit (WTRU) is configured to determine it is in measurement mode, compare a serving cell signal to a threshold to obtain serving cell strength and measure a non-serving cell based on the serving cell strength. The WTRU is further configured to determine a channel monitoring cycle. The WTRU is further configured to determine a time to trigger value.

### CROSS REFERENCE TO RELATED APPLICATION

This application claims the benefit of U.S. provisional application No. 61/013,800 filed Dec. 14, 2007, which is incorporated by reference as if fully set forth.

### BACKGROUND

The Third Generation Partnership Project (3GPP) has initiated the Long Term Evolution (LTE) program to bring new technology, new network architecture, new configurations and new applications and services to wireless networks in order to provide improved spectral efficiency and faster user experiences.

A wireless transmit/receive unit (WTRU) can function in Idle Mode or Connected Mode. While in Idle Mode or Connected Mode, the WTRU may need to acquire system information and system information updates, as well as information related to measurements and cell selection and reselection. It would be desirable to have a method and apparatus for effectively receiving parameters, determining cycles and scheduling, and determining measurement opportunities.

### SUMMARY

A method and apparatus is disclosed for a WTRU to transmit, receive and determine system information, paging information and non-serving cell measurements. This may include the WTRU performing non-serving cell measurements and determining cycles for monitoring system information updates. The WTRU may be configured to determine it is in measurement mode, compare a serving cell signal to a threshold to obtain serving cell strength and measure a non-serving cell based on the serving cell strength. The WTRU may further be configured to determine a channel monitoring cycle. Furthermore, the WTRU may be configured to determine a time to trigger value.

### BRIEF DESCRIPTION OF THE DRAWINGS

A more detailed understanding may be had from the following description, given by way of example and to be understood in conjunction with the accompanying drawings wherein:

FIG. 1 shows an example wireless communication system including a plurality of wireless transmit/receive units (WTRUs) and an eNodeB in accordance with one embodiment;

FIG. 2 is a functional block diagram of a WTRU and the eNodeB of FIG. 1 in accordance with one embodiment; and

FIG. 3 is a flow diagram of a method of measurement in accordance with one embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

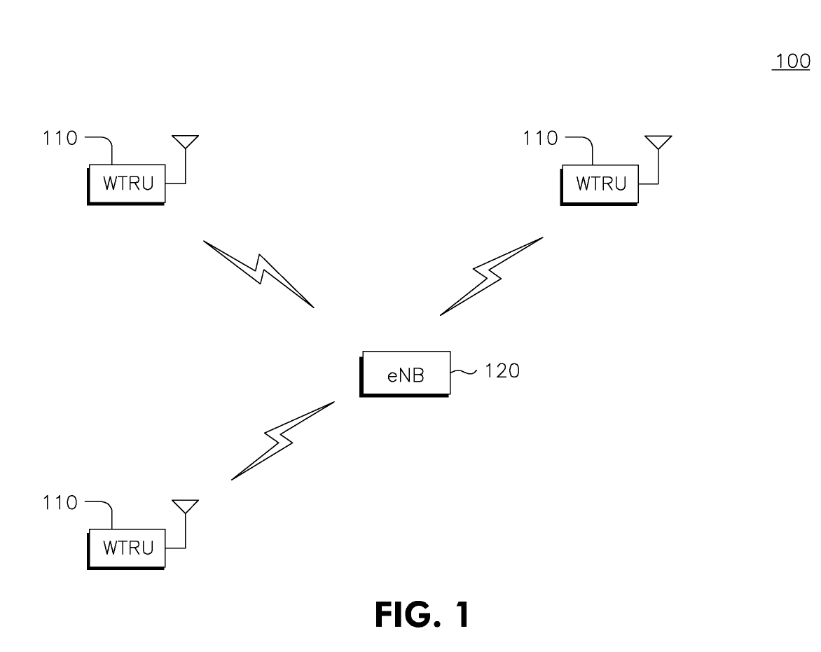

FIG. 1 shows a wireless communication system 100 including a plurality of WTRUs 110 and an e Node B (eNB) 120. As shown in FIG. 1, the WTRUs 110 are in communication with the eNB 120. Although three WTRUs 110 and one eNB 120 are shown in FIG. 1, it should be noted that any combination of wireless and wired devices may be included in the wireless communication system 100.

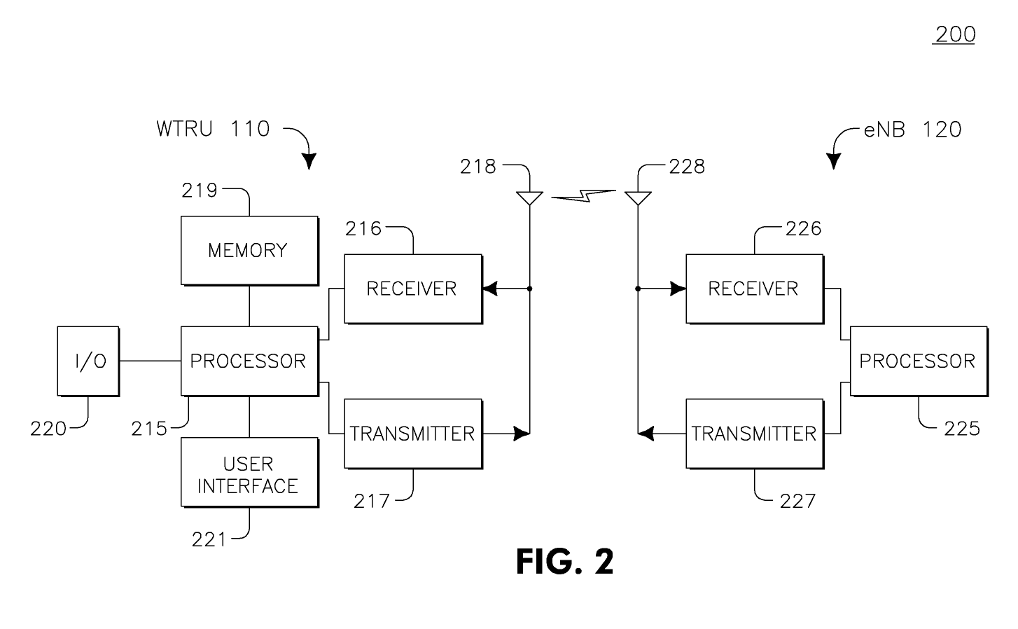

FIG. 2 is a functional block diagram 200 of a WTRU 110 and the base station 120 of the wireless communication system 100 of FIG. 1. As shown in Figure 1, the WTRU 110 is in communication with the eNB 120. The WTRU 110 is configured to receive system information and system information updates from the eNB 120. The eNB 120 may be configured to transmit, and the WTRU 110 configured to receive and monitor signals on the broadcast control channel (BCCH). The WTRU 110 may also be configured to operate in a discontinuous reception (DRX) mode and/or a discontinuous transmission (DTX) mode. The WTRU 110 may be configured to receive paging messages and other radio resource control (RRC) messages.

In addition to the components that may be found in a typical WTRU, the WTRU 110 includes a processor 215, a receiver 216, a transmitter 217, and an antenna 218. The WTRU 110 may also include a user interface 221, which may include, but is not limited to, an LCD or LED screen, a touch screen, a keyboard, a stylus, or any other typical input/output device. The WTRU 110 may also include memory 219, both volatile and non-volatile as well as interfaces 220 to other devices, such as universal serial bus (USB) ports, serial ports and the like. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical eNB, the eNB 120 includes a processor 225, a receiver 226, a transmitter 227, and an antenna 228. The receiver 226 and the transmitter 227 are in communication with the processor 225. The antenna 228 is in communication with both the receiver 226 and the transmitter 227 to facilitate the transmission and reception of wireless data.

System information may be changed during a specified modification period. An eNB may transmit the changes to a WTRU. In a first modification period, the eNB may notify a WTRU that a change is imminent. During a second modification period, at some time period after the first modification period, the new system information is signaled to the WTRU. When the WTRU receives a change notification, it knows that the current system is valid until the next modification period boundary.

A WTRU may monitor a downlink channel, such as the BCCH, for example, for system information changes. Furthermore, a WTRU may be operating in idle mode or in connected mode. When in either mode of operation, a WTRU may monitor downlink channels for system information changes in a regular time cycle.

A WTRU may enter idle mode when there is no activity. In idle mode, the WTRU is essentially “asleep” in order to, for example, save battery resources. It may use a discontinuous reception (DRX) cycle to wake up on a pre-scheduled basis to check for pages, or indications that the WTRU should switch to connected mode to receive and transmit messages. While the WTRU is operating in idle mode, a time cycle used by the WTRU to monitor downlink channels for information such as pages and system information changes, for example, is referred to as a paging cycle. WTRUs may also be placed in paging groups, wherein the WTRUs in a paging group each receive paging signals from a single eNB.

In order to determine the proper paging cycle, a WTRU may use the value of the paging group and/or a discontinuous reception (DRX) cycle. Both the idle mode paging group value and the idle mode DRX period may be signaled to the WTRU from an eNB in respective information elements (IEs).

In connected mode, a WTRU may check for system information changes by monitoring a downlink channel, such as the BCCH. If the WTRU is in connected mode, the WTRU may determine a monitoring cycle, which is analogous to the paging cycle, using a monitoring group and/or the DRX period, where the DRX period can be additionally parsed into a long DRX period or a short DRX period. The connected mode WTRU may determine the proper DRX period and use that to determine the monitoring cycle. The connected mode monitoring group and the DRX active period for connected mode may be signaled to the WTRU in respective IEs. Separate IEs may be signaled for short DRX periods and long DRX periods.

If a WTRU has switched from idle mode to connected mode, and the monitoring group for connected mode is not signaled, the WTRU may determine that the monitoring group is the same as the paging group that the WTRU was in during idle mode.

Alternatively, an integer value may be signaling to the WTRU. The WTRU may use the signaled value in place of the monitoring group. The signaled value may be, for example, a specific time or timing value, or may be an input to a formula used for calculating the monitoring period in connected mode. The signaled value may be used as a time period for a WTRU once it enters connected mode to periodically monitor the BCCH. The signaled value may be the same for all WTRUs in a cell, may be the same for a set of WTRUs in a cell, or may be different for each WTRU in a cell.

Alternatively, an eNB can define a radio network temporary identifier (RNTI) that may be used by a WTRU to monitor the BCCH in connected mode. The RNTI may be received by the WTRU in a system information message. The WTRU may use the same system information message to determine whether the system information blocks (SIB) have changed. A BCCH RNTI may be signaled in an IE to the WTRU.

Rather than receive individual IEs, as stated above, a single IE, for example, a Domain System IE, may be received by a WTRU. The Domain system IE may include the idle mode paging group, idle mode DRX period, connected mode paging group, connected mode DRX active period and the BCCH radio network temporary identifier (RNTI). The connected mode active DRX period may further be parsed in short and long DRX active periods. The domain system IE may be included in a system information block (SIB), such as SIB 1 or SIB 2, for example.

During a system information modification period, a group of WTRUs may monitor and read the system information updates at the same time. This may result in a surge in uplink traffic after all the WTRU's have finished reading the update.

In order to prevent a surge in uplink traffic after each WTRU or WTRU group reads an update, each WTRU that requires a grant may generate a back-off parameter for access to an uplink channel, such as the random access channel (RACH). The WTRU may automatically perform a back-off procedure after reading the new system information if the WTRU determines that it requires an uplink grant.

While the WTRU may receive the new system information as set forth above, the WTRU may require additional information to determine when to apply the new information. The additional information used to determine when to apply the new system information may include time data, such as a system frame number (SFN), for example. FN), for example. The activation time may be the same across a WTRU group or different for different WTRUs or WTRU groups. The additional information may be signaled to the WTRU, broadcast in a cell or generated by the WTRU.

A WTRU may detect a change in the access service class (ASC) configurations while reading an SIB. If the WTRU determines that the ASC configurations have changed in new system information, the WTRU may delete all grants and initiate the procedures to request a new grant. Alternatively, the WTRU may delete all grants and initiate the procedures to request a new grant if only its own ASC has changed.

A WTRU may operate in one of three mobility states, low, medium, or high. A time-to-trigger (TTT) may be specified for one of the mobility states that the WTRU may operate in and signaled to a WTRU along with a scaling factor for the other mobility states the WTRU may operate in. The WTRU may apply the scaling factor to the specified TTT for one mobility state to obtain a TTT for another mobility state.

A WTRU may receive an IE that includes a scaling factor for TTT for high mobility with a value for the TTT for medium mobility. The WTRU may multiply the TTT value for medium mobility by the scaling factor to determine the TTT for high mobility state. Furthermore, if a scaling factor for low mobility is received by the WTRU, the WTRU may multiply the low mobility scaling factor by the medium mobility TTT value to obtain the low mobility TTT value.

The value of hysteresis time may be used with a speed detection mechanism to determine TTT. For example, the WTRU may use a measure of a variation in a neighbor list or may measure a number of handovers in a certain time as a measure of speed. This gives the WTRU its mobility rate. The time period over which the measurement is done is time, T. WTRU may add hysteresis time to the speed measurement at the end of time T to determine mobility rate.

Scaling factors may be received by WTRU in one or more IEs. Different sets of speed dependent scaling parameters for connected mode may be signaled and may be used by the WTRU whether the WTRU is measuring an intra-frequency, inter-frequency or inter-radio access technology (RAT) cell. The speed dependent parameters may also be received by the WTRU in a measurement configuration IE. The measurement configuration IE may be signaled as part of the measurement control message, in an SIB or in another RRC message.

At various time intervals, a WTRU may be required to measure the signal strength of a serving cell or a non-serving cell. The non-serving cell may be functioning in a different frequency and/or a different radio access technology than the serving cell.

However, a WTRU may not continually perform measurement routines. The WTRU may be triggered to perform measurement routines at particular times. The trigger may occur upon an event, such as, reaching a threshold of a minimum acceptable cell quality measured in, for example, reference signal received power (RSRP). A trigger may occur, for example, when a serving cell signal becomes better than the minimum acceptable cell quality. The trigger may act to delay a measurement procedure. As long as the cell quality is high, a measurement procedure may be delayed.

The same minimum acceptable cell quality may be used as a floor. A trigger may occur when a serving cell signal falls below the threshold. In this case, the trigger acts as a positive trigger and influences the WTRU to start making measurements.

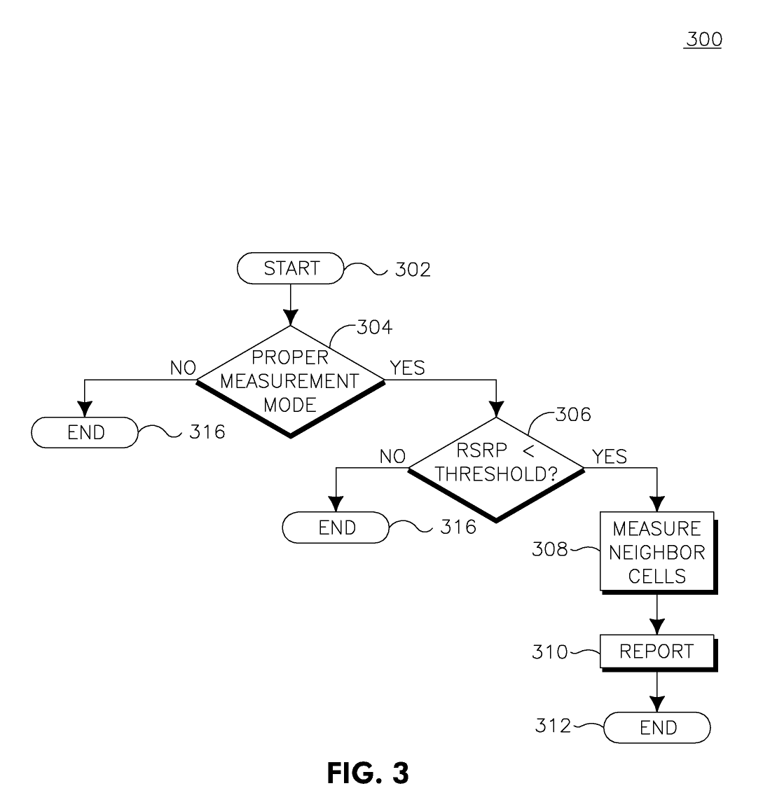

FIG. 3 is a flow chart of a measurement method 300 in accordance with one embodiment. At 302, the measurement routine is started based on parameters the WTRU receives in an IE. At 304, the WTRU determines if it is in a proper mode for measurements. This may include, for example, the WTRU being in idle mode or the WTRU being in connected mode with configured measurement gaps. If the WTRU is not properly configured to make measurements, at 316, the process ends. However, if the WTRU is properly configured to make measurements, at 306 the WTRU determines if the serving cell signal is below a threshold. If so, this triggers the WTRU to measure neighbor cells, at 308. At 310, the WTRU reports the non-serving, or neighbor cell, measurements and ends the measurement process at 312. If the serving cell signal meets or exceeds the threshold, at 316, the process ends without the WTRU performing any measurements of non-serving cells.

Although the features and elements are described in embodiments in particular combinations, each feature or element can be used alone without the other features and elements or in various combinations with or without other features and elements. The methods provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of a wireless transmit receive unit (WTRU) to perform non-serving cell measurements, the method comprising:
the WTRU determining it is in measurement mode;
the WTRU comparing a serving cell signal to a threshold to obtain a serving cell strength; and
the WTRU measuring a non-serving cell based on the serving cell strength.

2. The method as in claim 1 further comprising the WTRU determining if it is in idle mode.

3. The method as in claim 1 further comprising the WTRU determining:
if it is in connected mode; and
if measurement gaps are configured.

4. The method as in claim 1 further comprising the WTRU measuring serving cell strength based on a reference signal received power (RSRP).

5. A method of a wireless transmit receive unit (WTRU) to perform non-serving cell measurements, the method comprising:
the WTRU determining it is in measurement mode;
the WTRU comparing a serving cell signal to a threshold to obtain a serving cell strength; and
the WTRU delaying measurement of a non-serving cell based on the comparing of the serving cell strength.

6. A method of determining a channel monitoring cycle in a wireless transmit receive unit (WTRU), the method comprising:
the WTRU receiving a group value;
the WTRU receiving a discontinuous reception (DRX) value; and
the WTRU determining the paging cycle based on the paging group value and the DRX value.

7. The method as in claim 6 wherein the monitoring cycle is a paging cycle and the group value is a paging group value.

8. The method as in claim 6 wherein the group value is a monitoring group value.

9. A method of determining a channel monitoring cycle in a wireless transmit receive unit (WTRU), the method comprising:
the WTRU determining a monitoring group based on a paging group; and
the WTRU determining a channel monitoring cycle based on the monitoring group.

10. A wireless transmit receive unit (WTRU) configured to perform non-serving cell measurements, the WTRU comprising a processor configured to:
determine a measurement mode;
compare a serving cell signal to a threshold to obtain a serving cell strength; and
measure a non-serving cell based on the serving cell strength.

11. The WTRU as in claim 10 wherein the processor is further configured to determine if it is in idle mode.

12. The WTRU as in claim 10 wherein the processor is further configured to:
determine if it is in connected mode; and
determine if measurement gaps are configured.

13. The WTRU as in claim 10 wherein the processor is further configured to measure serving cell strength based on a reference signal received power (RSRP).

14. The WTRU as in claim 10, wherein the WTRU is configured to measure a non-serving cell operating at a different frequency than a serving cell.

15. The WTRU as in claim 10, wherein the WTRU is configured to measure a non-serving cell operating in a different radio access technology as a serving cell.

16. A wireless transmit receive unit (WTRU) configured to perform non-serving cell measurements, the WTRU comprising a processor configured to:
determine that the WTRU is in measurement mode;
compare a serving cell signal to a threshold to obtain a serving cell strength; and
delay a measurement of a non-serving cell based on the serving cell strength.

17. A wireless transmit receive unit (WTRU) configured to determine a channel monitoring cycle, the WTRU comprising:
a receiver configured to receive a group value and a discontinuous reception (DRX) value; and
a processor configured to determine a paging cycle based on the group value and the DRX value.

18. The WTRU as in claim 17 wherein the channel monitoring cycle is a paging cycle and the group value is a paging group value.

19. The WTRU as in claim 17 wherein the group value is a monitoring group value.

20. A wireless transmit receive unit (WTRU) configured to determine a channel monitoring cycle, the WTRU comprising a processor configured to:
determine a monitoring group based on a paging group; and
determine a channel monitoring cycle based on the monitoring group.

21. A method of determining a time to trigger value, the method comprising:
a WTRU receiving a time to trigger value for a first mobility state;
the WTRU receiving a scaling factor for a second mobility state; and
the WTRU multiplying the scaling factor and the time to trigger value to determine a value for the second mobility state.

22. The method as in claim 21 further comprising:
the WTRU receiving a scaling factor for a third mobility state; and
the WTRU multiplying the scaling factor of the third mobility state by the time to trigger value for the first mobility state to obtain a value for the third mobility state.
